(19) United States
(12) Patent Application Publication
(10) Pub. No.: US 2007/0125203 A1
(43) Pub. Date: Jun. 7, 2007

(54) Worm, worm gear wrench

(76) Inventor: Bill Nguyen, Carson, CA (US)

Correspondence Address: SELDON & SCILLIERI, 10940 WILSHIRE BLVD., 18TH FLOOR, LOS ANGELES, CA, 90024-3952, US

(21) Appl. No.: 11/295,180

(22) Filed: Dec. 7, 2005

(51) Int. Cl. B25B 17/00; B25B 21/00; B25B 23/16; B25G 1/00

(52) U.S. Cl. 81/57.29; 81/57.13; 81/177.85

(57) ABSTRACT

An improved worm/worm gear wrench which is particularly adapted to use with or Without a cordless electrical hand/air drill for loosening or tightening bolts or nuts In tight areas (for example: spark plugs in the cars). A worm/worm gear wrench is comprised of a worm shaft handle for bidirectional rotation. This drives a worm gear and is adapted for receiving the conventional socket or extension socket. The worm shaft handle and the worm gear are fixed relatively to the housing and filled with grease to lubricate the worm and worm gear teeth.

### BACKGROUND OF INVENTION

1. Field of the Invention

The present invention relates to a worm/worm gear wrench and more particularly concerns a wrench which is adapted to use in tight areas where swinging rotational movement of the wrench handle is difficult or impossible.

2. Brief Description of the Prior Art

It is difficult for auto mechanics, or people who work on cars, to access tight areas to tighten or loosen spark plugs, nuts, or bolts. This is often done with conventional ratchet wrenches with an elongated handle or extensions bar socket. The conventional ratchet wrench handle swings backward and forward within an angle to loosen or tighten spark plugs, nuts, or bolts.

Therefore, a long-standing need has existed to provide a novel bidirectional worm/worm gear wrench that can easily tighten or loosen spark plugs, nuts, or bolts in tight areas.

### SUMMARY OF THE INVENTION

The above problems and difficulties are avoided by the present invention which provides a bidirectional worm/worm gear wrench comprised of a rotating worm shaft handle and a worm gear having a sockets drive. The worm gear assembly also includes a worm for driving the worm gear and rotation perpendicular to each other inside the housing. The worm shaft handle is provided with diamond knurls and a female square at one end for rotating the shaft by hand or by inserting the universal joint for faster rotation of the worm gear/socket drive member by means of a cordless electrical hand drill.

This invention presents a Bidirectional worm/worm gear wrench which is more efficient for use in loosening or tightening spark plugs, nuts, and bolts in tight areas. This wrench has higher torque and a rotating shaft whose square female socket at the end can be used with existing tools (universal joint, extensions bar, cordless electric drill, air drill, ratchet wrench).

### BRIEF DESCRIPTION OF THE DRAWINGS

The features of the present invention are believed to be novel and are set forth with particularity in the appended claims. The present invention, both as to its organization and manner operation, together with further objects and advantages thereof, may best be understood with reference to the following description, taken in connection with the accompanying drawings:

FIG. 1 is an enlarged view of the invention.

FIG. 2 is a side view of the double socket drive.

FIG. 3 is a side view of the single socket drive.

FIG. 4 is a partially cross-sectional front view of a square socket drive assembly incorporating the subject worm/worm gear assembly and the connecting between universal joint/extension bar and a cordless electrical drill.

FIG. 5 is a view of driving worm/worm gear and the housing mounting assembly.

### DESCRIPTION OF PREFERRED EMBODIMENT

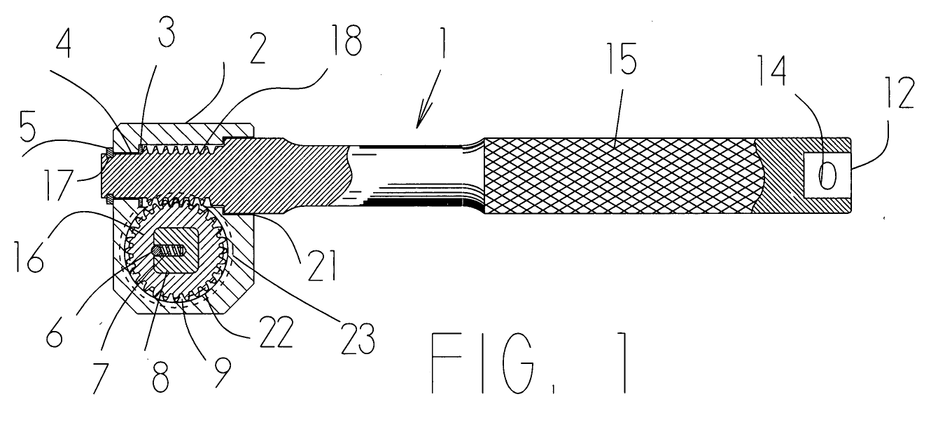

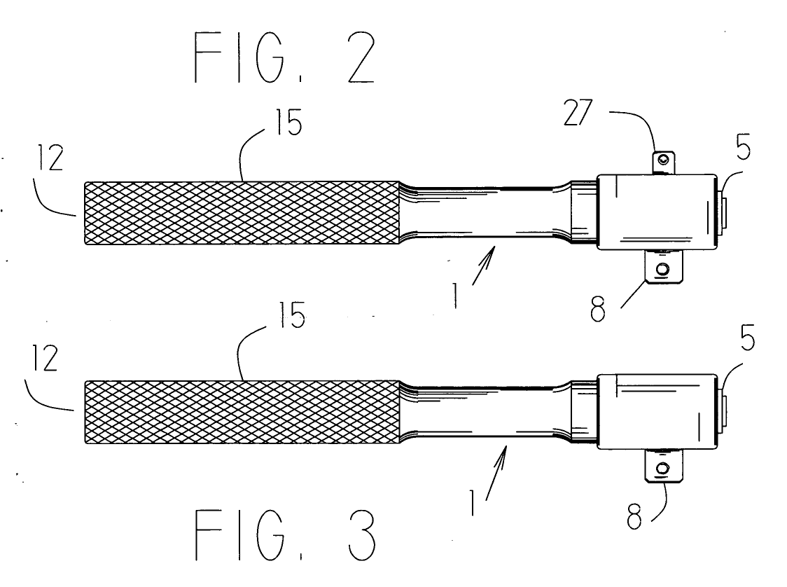

Referring to FIG. 1 the reference numeral 1 indicates a wrench constructed in accordance with the present invention.

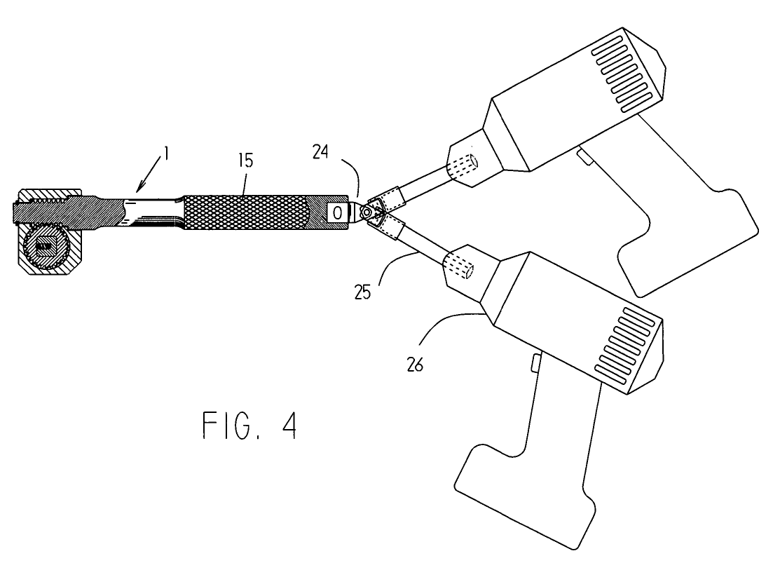

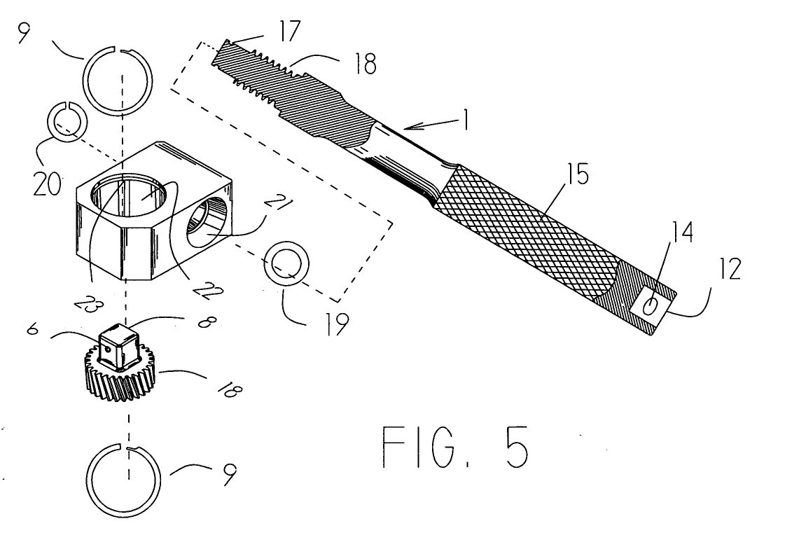

The wrench 1 has a rotating shaft diamond knurl handle 15 with a worm thread 18 which has retaining grooves 17 and at the other end, the female square 12. Four recessed grooves 14, FIG. 4 can be effectively extended through the use of a universal joint 24, an extension bar 25, or a cordless electrical hand drill 26. FIG. 1, a curved disc spring 3 and a snap ring 5 is installed into retaining groove 17 to keep the handle and housing together. The handle provides diamond knurling for hand grip 15.

A worm gear 16 includes the male square extension 8, a spring 7 to push out the steel ball 6 and prevent the socket from falling out. The worm gear is installed into the second axis 22, between two internal retaining rings 9 which are installed into two internal retaining grooves 23, perpendicular with first axis 4 and counter bore 21.

The worm 18 and the worm gear 16 engage within the housing 2 during operation of the wrench, the square socket drive has a higher torque output, easily tightening or loosening of spark plugs, nuts, and bolts in tight areas.

While particular embodiments of the present invention have been shown and described, it will be obvious to those skilled in the art that changes and modifications may be made without departing from this invention in its broader aspects and therefore, the aim in the appended claims is to cover all such changes and modifications as fall within the true spirit and scope of this invention.

What is claimed is:

1. A wrench for loosening or tightening bolts or nuts comprised of:
An elongated bidirectional rotating drive shaft handle including:
An external retaining grooved
A worm single or double or triple start thread
A female socket head with 4 recessed grooves
A housing for assembly worm/worm gear with the first axis and the second axis crossing perpendicularly
A worm gear having a single male square socket drive
A worm gear having a double male square socket drive.
